(19) United States
(12) Patent Application Publication
(10) Pub. No.: US 2009/0277015 A1
(43) Pub. Date: Nov. 12, 2009

(54) Release Button for Folding Knife

(75) Inventor: Wes DUEY, Oregon City, OR (US)

Correspondence Address: HANCOCK HUGHEY LLP, P.O. BOX 1208, SISTERS, OR, 97759, US

(73) Assignee: Mentor Group, L.L.C., Oregon City, OR (US)

(21) Appl. No.: 12/116,552

(22) Filed: May 7, 2008

(51) Int. Cl. B26B 1/04

(52) U.S. Cl. 30/160; 30/164; 30/158

(57) ABSTRACT

In a folding knife in which a release button is used to lock the blade in the open and/or closed positions, and to release the blade from being locked, the release button has a shank portion that does not extend past the axial centerline through the button. The tang of the blade may therefore be made long enough that the lockup between the tang and the release button is more secure.

### FIELD OF THE INVENTION

This invention relates to folding knives that rely upon a release button to lock the blade in either the open or closed position, or both, and to release the blade when it is locked to move it from one position to another. More specifically, the invention relates to an improved release button for such knives.

### BACKGROUND

There are many types of knives, both automatic and manual, that utilize trigger-activated mechanisms that allow an implement to be moved between a folded position in which the implement is safely stowed in the tool handle, and an extended position in which the implement is ready for work. Of course, automatic versions of these knives include spring mechanisms that automatically drive the blade into the open position; manual knives require the blade to be moved manually from closed to open. The knife handle typically has two opposed handle portions defining a blade-receiving groove. A blade pivots on a shaft attached to the handle such that in a folded position the blade is stowed with the cutting portion of the blade safely in the groove, and such that in an extended position the blade is extended away from the handle, ready for use. The trigger mechanism controls movement of the blade from the closed to the open position—that is, when the blade is closed and the trigger is actuated, the blade may be moved either automatically or manually to the open position.

As noted, automatic opening knives include some kind of a spring-like or spring-driven mechanism that urges a blade from the closed position to the open position. In the closed position the blade must be locked against the constant opening force of the spring applied to the blade. Typical springs include spirally wound torsion springs that are wrapped around the pivot axis of the blade and which on one end engage the pivot pin, handle, liner or some other fixed, non-rotational structure, and on the other engage the blade. Other designs use compression springs and still others use extension springs and spiral wound flat springs and leaf springs. Many automatic opening mechanisms utilize or adapt the well-known sear type of design. Regardless of the particular mechanism used, when the locking mechanism is released, the spring forces the blade into the open position.

Preferably, push-button knives of the kinds described herein also include a locking mechanism that locks the blade in the open position. There are many designs for locking mechanisms to accomplish this task. Generally speaking, when the knife blade pivots into the open position, the blade's pivotal movement is stopped with a transverse blade stop pin housed in the handle. The locking mechanism is included to prevent the blade from pivoting back from the open into the closed position until the user purposefully closes the knife.

One common type of locking mechanism is a “liner lock.” This kind of mechanism relies upon a resilient lever formed as part of a handle liner. When the blade is pivoted to the open or extended position, the resilient lever engages a cooperatively formed ramp on the blade and thereby locks the blade in the open position.

Two separate patents describe different types of automatic knives that use push-button release mechanisms: U.S. Pat. No. 5,822,866 and U.S. Pat. No. 7,278,213. Both of these patents are described briefly below. Both are owned by the assignee of the present invention and both are incorporated herein by this reference.

The automatic opening knife detailed in the '866 patent relies on a push button bolt mechanism that includes a locking body that has a cylindrically tapered side wall portion. When the blade is extended to the open position, the tapered side wall portion of the locking body is urged by a compression spring into a locking position in which the locking body wedges between an engagement surface on the blade and a bore in the handle to lock the blade in the open position.

The locking mechanism for automatic knives disclosed in U.S. Pat. No. 7,278,213 also relies upon a push-button type of bolt. The trigger mechanism has a bolt that extends transverse to the handle. When an exposed portion of the trigger mechanism is depressed the bolt moves laterally in the knife handle. Once the bolt clears the tang of the blade, the blade disengages from the bolt and is swung to the open position by a spring.

The release buttons, also known as lock buttons, or “bolts” described in the two patents just mentioned are critical components of the knives since they control the opening mechanisms, and also lock the blade in both the open and closed positions. The bolts are defined by a trigger button end that is exposed to the outside of the handle, a tapered locking end at the opposite end, which is housed internally in the handle, and a central, axial and cylindrical shaft or shank interconnecting the two ends. When the button end is pushed, the bolt moves laterally in the handle. As the bolt moves, the tang of the blade, which is driven rotationally by a coil spring, has enough clearance to move past the bolt because the central shank is relatively small in diameter, thereby allowing adequate clearance and allowing the blade to rotate to the open position. Once the blade is in the open position, its rotation having been stopped by a stop pin, the pressure on the bolt is released and the tapered locking end of the bolt engages a portion of the tang, thereby locking the blade in the open position and preventing movement of the blade to the closed position.

The axial shank portion of the stop pins described in the patents just mentioned allows the pin to be oriented in an rotational position in the handle. In other words, the tang is able to swing past the shank of the pin regardless of whether the pin rotates about its long axis in the handle. However, this design inherently limits the configuration of the blade tang. Specifically, in order to provide enough clearance for the blade tang to clear the central shank of the bolt, the tang must be relatively short and make lock-up contact with the tapered locking portion of the bolt at a locking corner edge portion of the tang—if the tang were any longer, the tang would not be able to clear the axial central shank and the blade could not be opened or closed. Because the blade tang makes lock-up contact at a point on the bolt that is less than 50 percent of the distance across the bolt—that is, less than the axial centerline through the bolt, there is shearing force exerted on the trigger button.

There is a need therefore for an improved and more robust release button mechanism for use in a knife that relies upon a push button type of release and locking mechanism.

The present invention relates to an improved design for a release button or bolt for use in a push-button type release folding knife, in which the button serves to control the locking/opening mechanism, and to lock the blade in either the open or closed positions, or both positions.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective view of an automatic opening folding knife that is exemplary of the type that incorporates a release button in accordance with the illustrated invention. In FIG. 1 the knife blade is shown in the open position.

FIG. 2 is a perspective view of the knife shown in FIG. 1 with the blade stowed in the closed position.

FIG. 3 is an exploded perspective view of the knife shown in FIG. 1, illustrating the component parts.

FIG. 4 is a close up, partially cut away view of selected components of the knife shown in FIG. 1 with the blade in the open position and illustrating a release button and blade tang formed in accordance with the illustrated invention.

FIG. 5 is a perspective view of the release button according to the present invention.

FIG. 6 is a sectional view of the release button shown in FIG. 5, taken along the line 6-6 of FIG. 5, illustrating a portion of the blade tang in relation to the release button.

FIG. 7 is a side elevation view of the release button and a portion of the blade tang, illustrating the lock up position.

FIG. 8 is a close up, partial sectional and partially cut away view of the knife shown in FIG. 1 with the blade in the closed position and illustrating a release button according to the present invention.

FIG. 9 is a close up, partial sectional and partially cut away view similar to the view of FIG. 8 except with the blade in the open position.

FIG. 10 is a sectional view taken along the lines 10-10 of FIG. 9, showing a completely assembled knife.

### DETAILED DESCRIPTION OF THE PREFERRED EMBODIMENTS

The present invention relates to a release button for use in both automatic and manual folding knives. The release button functions as a lock button, since it locks the blade in both the open and closed positions. And while the release button described herein may be utilized in both manual and automatic folding knives, it is described and illustrated in the context of an automatic opening knife. Those of ordinary skill in the art will readily understand that the same release button described herein and shown in the drawings in an automatic knife may be used interchangeably in a manual knife. It will further be understood that in a manual knife the release button often is used to lock the blade only in the open position, rather than using the button to lock the blade in both the open and closed positions.

A preferred embodiment of an automatic opening knife 10 incorporating a release button in accordance with the illustrated invention is shown in the figures. Although the invention is described with respect to a particular style of knife, it will be appreciated that references to this style of a knife, and indeed this particular mechanisms for an automatic knife, are for illustrative purposes to describe the invention. Those of ordinary skill in the art will appreciate that the invention claimed herein is not limited to knives, but instead extends to any hand tool having the features claimed herein.

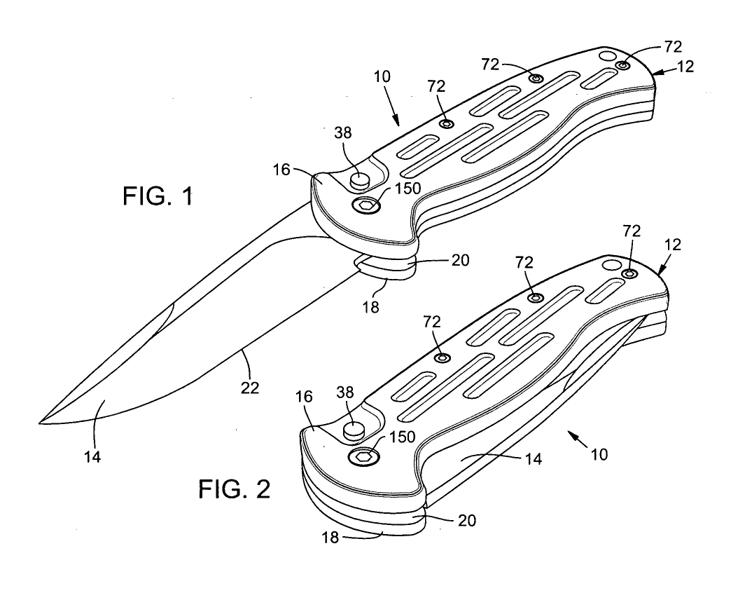

With reference to FIGS. 1 through 3, knife 10 includes a handle 12 and a blade 14. Handle 12 includes two side wall portions or halves 16 and 18 that are held parallel to one another in a spaced apart relationship with various screws and the like to define a blade receiving groove 20 therebetween. Handle 12 defines a longitudinal body axis. Blade 14 is pivotally attached to handle 12 near the “forward” end of handle 12 with a pivot shaft 24 that is transverse to the longitudinal body axis, and which has its opposite ends fixed to the handle halves 16 and 18. When the blade 14 is in the retracted or closed position shown in FIG. 2, the working or sharp portion 22 of the blade is safely stowed in groove 20. As a linguistic convention, relative directional terms used herein correspond to the geometric center of the knife and how the knife is used in normal usage conditions. Using this convention, the front or forward of the handle is where pivot shaft 24 extends through the handle. The “rear” or butt end of the handle is opposite the forward end; the “upper” part of the blade is the dull, non-working portion and the “lower” portion of the blade is the sharpened, working portion. “Inner” or “inward” refers to the geometric center of the knife 10; the “forward” end of blade 14 is its tip, and so on.

The knife 10 shown in the figures includes an automatic opening mechanism similar to the types described in the two U.S. patents mentioned above, namely, U.S. Pat. Nos. 5,822,866 and 7,278,213. Preferably, an automatic opening knife 10 of the type shown in the figures includes a safety mechanism that prevents unintentional activation of the automatic opener mechanism. Although a safety mechanism is not shown in FIGS. 1-10, it will be understood that a knife 10 as shown herein that includes an automatic opener preferably includes a safety mechanism.

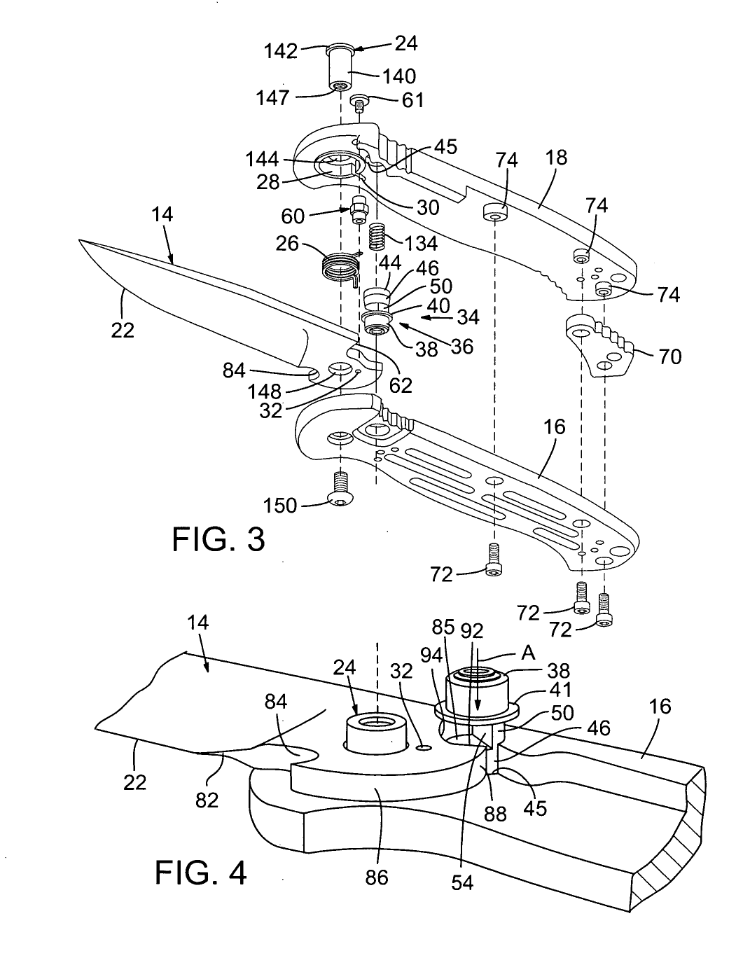

With reference now to FIGS. 3 and 4, the automatic opening mechanism incorporated in knife 10 is defined by a coiled wire spring 26 that is housed in a recess 28 formed in handle half 18. Spring 26 extends around shaft 24 in the assembled knife 10 and has one end fixed in a slot 30 in handle half 18, and the opposite end inserted into a bore 32 in blade 14. During assembly of the knife, spring 26 is wound so that it provides an opening elastic force for urging blade 14 toward the open position at all times, namely, when the blade is in the closed position as in FIG. 2 and when the blade is in the open position of FIG. 1.

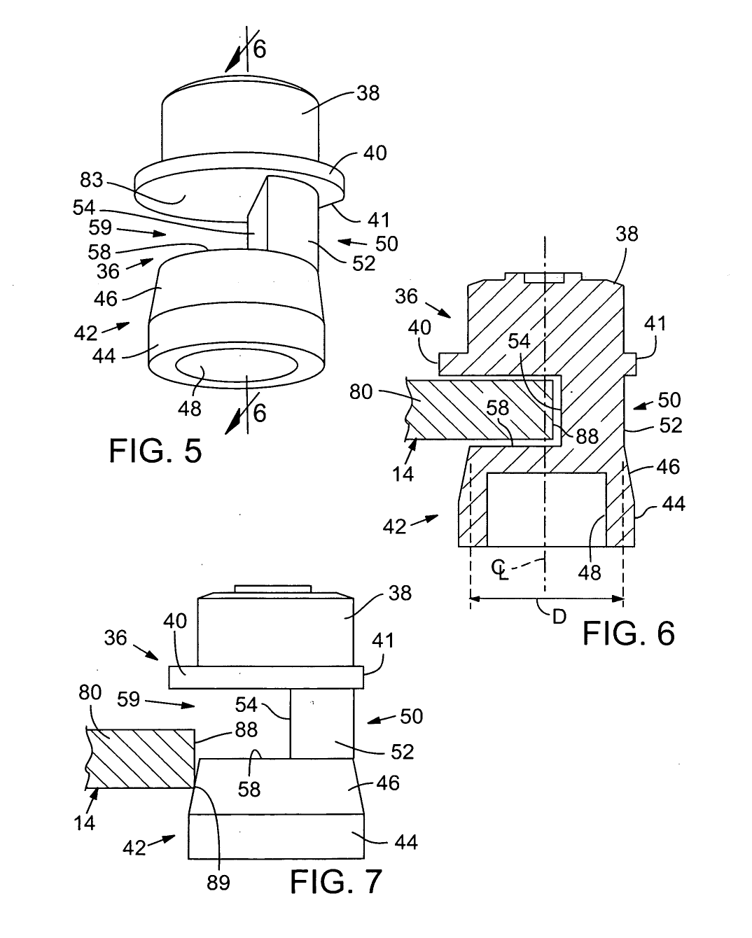

The automatic opening mechanism used in knife 10 is actuated with a trigger mechanism, generally referenced herein with number 34. Trigger mechanism 34 includes a bolt 36—sometimes also called a release pin or release button, that is spring-loaded and extends in a transverse direction between handle halves 16 and 18, parallel to shaft 24. The bolt 36 is shown in isolation in FIGS. 5, 6 and 7 and comprises three separately identifiable structural features that together define the bolt: a button end, a locking end, and a shank that interconnects the two ends. As detailed herein, the release bolt serves dual functions. Thus, it serves to release the blade so that the blade may be moved between the open and closed positions. Second, it serves to lock the blade in both the open and closed positions. As such, the release bolt 36 may aptly be called a release/lock bolt.

The first structural feature of bolt 36 is a button end 38 that is at the proximate end of the bolts and which is exposed out of handle half 16 in the assembled knife (FIG. 1) and which is operable by a user to open the knife. A flange 40 having a diameter greater than the diameter of button end 38 extends radially around the base of the button end 38 of bolt 36 and functions to retain the cross bolt housed in the assembled knife. Flange 40 has a flattened portion 41 that, as detailed below, maintains the position of bolt 36 relative to handle 12 and prevents the bolt from rotating relative to the handle.

The second structural feature of bolt 36 is the end of the bolt opposite of button end 38, on the distal end of the bolt, which defines a locking body 42. Locking body 42 has a large diameter portion 44. Immediately adjacent the larger diameter portion is a tapered sidewall portion 46. The diameter of tapered sidewall portion 46 decreases gradually from the relatively larger diameter portion to an edge portion 58. Locking body 42 has a hollow base 48.

The third structural feature of bolt 36 is an off-center shank 50 that interconnects button end 38 to locking body 42. The off-center shank 50 is defined by a cylindrical outer wall portion 52 that extends partially around the perimeter of the bolt 36 and a flattened central portion 54 that extends across the bolt transversely to the longitudinal axis through the bolt. The outer wall portion 52 follows the same outer periphery as the outer peripheral wall of button end 38, and also the outer peripheral dimension of tapered sidewall portion 46 measured the “upper” limit of the tapered sidewall portion—that is, at edge portion 58. As shown in FIG. 6, the mass of material that makes up shank 50 does not extend past the axial centerline C_{L} that extends through bolt 36. Thus, flattened central portion 54 transects bolt 36 in a position such that the shank 50 occupies less than 50 percent of the distance D shown in FIG. 6, which is the diameter of bolt 50 measured at the edge 58 where tapered sidewall portion 46 ends and shank 50 begins. Off-center shank 50 thus defines a passageway through bolt 36, identified with reference number 59, and which is bordered by the interior surface 83 of flange 40 on one side, the interior surface 85 on the opposite side (see FIG. 4), and flattened central portion 54 on the lateral side that defines a planar side wall of the passageway.

Bolt 36 is preferably fabricated from a strong metal so it can withstand the rigors of repeated use, and preferably is monolithic. The bolt may be formed in any appropriate manner, for example by machining, molding or casting.

With returning reference to FIG. 3, in the assembled knife, blade 14 is pivotally attached to the handle halves 16 and 18 with pivot shaft 24. Pivot shaft 24 has an outer sleeve portion 140 and a lip 142 that has a diameter that is greater than the diameter of the sleeve portion. Sleeve 24 is inserted into and preferably press fit into a bore 144 in handle half 18 that has a stepped diameter that defines a lip 145 on which lip 142 of shaft 24 rests. The opposite end 147 of shaft 24 is locationally fit in a corresponding bore 146 in handle half 16. The shaft 24 extends through a bore 148 formed in the tang portion of blade 14. A bolt 150 threads into an internally threaded bore in sleeve 140 to retain the pivot shaft 24 in position.

A spacer 70 is positioned between handle halves 16 and 18 at the rearward end of handle 12 to maintain the handles in a spaced-apart relationship, and the handle halves are attached to one another with a variety of fasteners such as screws 72 that extend through bores in handle half 16 and thread into threaded bosses 74 on handle half 18. A blade stop pin 60 (which preferably is of the type described in U.S. Pat. No. 7,278,213) extends parallel to pivot shaft 24 and has its opposite ends fixed in the handle halves 16 and 18, respectively, with for example a screw 61. When the blade 14 is in the open position shown in FIG. 1, a shoulder 62 formed on blade 14 abuts stop pin 60 to thereby stop rotational movement of blade 14. This is best shown in FIG. 9. The position of blade 14 when shoulder 62 abuts stop pin 60 is defined as the stop position—that is, the fully open position. When shoulder 62 abuts stop pin 60 the blade 14 is locked in this open position by the action of bolt 36, as detailed below.

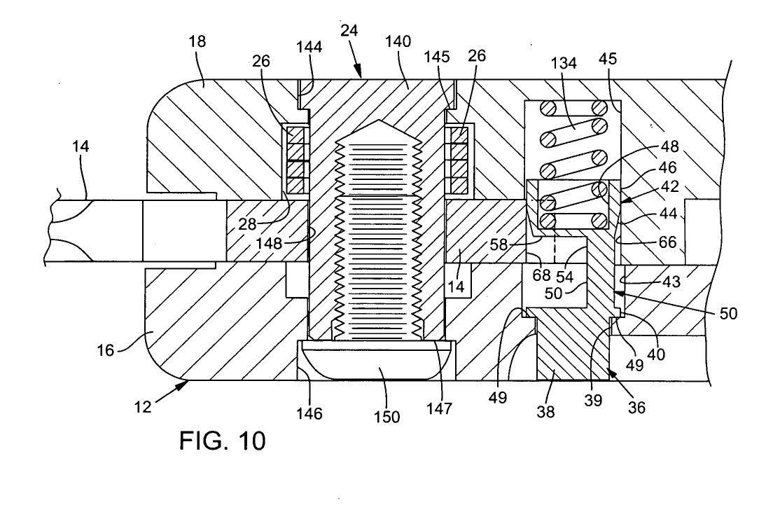

As best shown in FIGS. 3 and 10, in the assembled knife, the locking body 42 of bolt 36 is received in cylindrical, dead-end cavity 45 formed in handle half 18 with a compression spring 134 received in the hollow base 48 in locking body 42. The diameter of cavity 45 is slightly greater than the diameter of locking body 42 measured at the relatively larger diameter portion 44. This allows the bolt to move in an up and down fashion in the cavity, as described below. The opposite end of bolt 36, that is, button 38 extends through a bore 39 in handle half 16 such that the button is exposed to the exterior of the knife 10. Inwardly of bore 39 and axially communicating with bore 39 is an interior bore portion in handle half 16 that is identified with reference number 43. The diameter of bore 43 is slightly larger than the diameter of flange 40. The diameter of bore 39 is less than the diameter of bore 43, defining a lip 49. The diameter of bore 39 at lip 49 is smaller than the diameter of flange 40. Bolt 36 is retained in handle 12 with the flange 40 positioned interiorly of bore 39, and as such, bolt 36 is retained in the handle and cannot be removed from the handle by virtue of the flange 40. The spring 134 resides in the cavity 45 and in the hollow base 48 of the locking body and at all times urges bolt 36 away from handle half 18. As noted, flange 40 includes a flattened portion 41. A corresponding portion of bore 43 is similarly flattened. Accordingly, when bolt 36 is assembled with the handle halves 16 and 18 as detailed above and as shown in FIG. 10, the flattened portion 41 of flange 40 is mated with and aligns with the flattened portion of bore 43. This face-to-face orientation between the mated flattened portions of flange 40 and bore 43 defines means for preventing rotation of bolt 36 relative to handle 12, and around the longitudinal axis running through the bolt.

It will be appreciated that the position of the flattened portion 41 and the corresponding flattened portion of the bore 43 similarly maintain the position of the flat central portion 54 of shank 50. As detailed below, this maintains the bolt in the correct rotational position at all times, which allows the trigger mechanism 34 to operate. It will further be appreciated that there are numerous equivalent structures and mechanisms that could be used to fix the rotational position of bolt 36 relative to handle 12. For example, the flattened portion 41 of flange 40 could be replaced with a key on button 38 and a corresponding keyway formed in the handle. Alternately, a key and keyway could be formed on the locking portion 42, or relative rotation between the bolt and handle may be prevented by flattening facing surfaces of the locking portion 42 and cavity 45. These are just a few examples of structures that will serve the function of preventing relative rotation between the bolt and the knife handle. Those of ordinary skill in the art will recognize the many equivalent alternative structures available to define means for fixing the rotational position of the bolt relative to the handle, and for preventing rotation of the bolt in the handle.

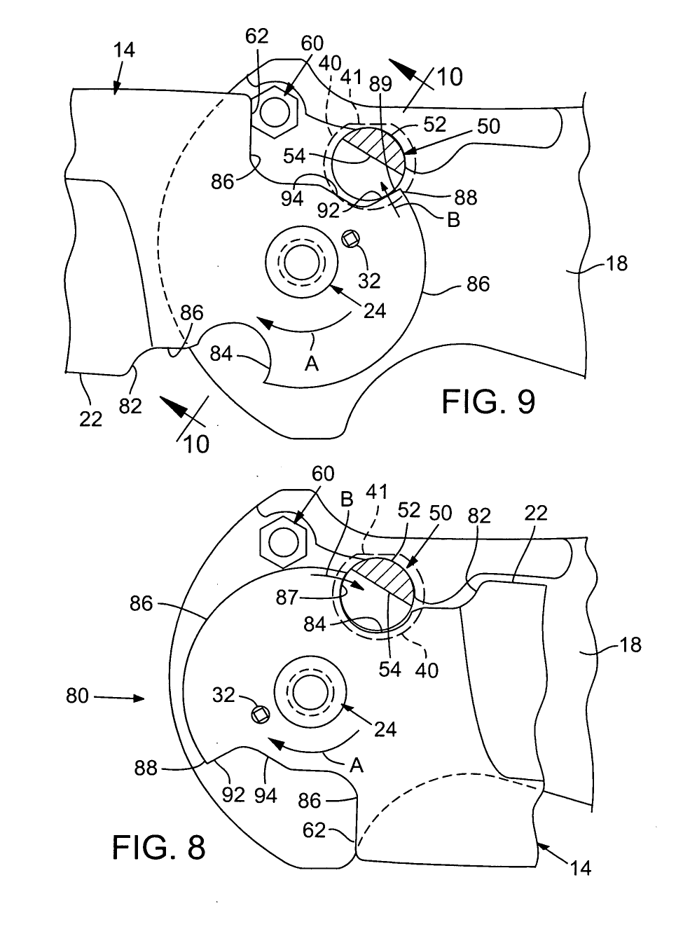

The tang 80 of blade 14 will now be described in detail with particular reference to FIGS. 8 and 9. The description of tang 80 will begin with sharpened edge 22 of blade 14 and will trace the edge 86 of tang 80 in a counterclockwise direction in FIG. 9. Sharpened edge 22 of blade 14 terminates at a shoulder 82. Adjacent and rearward of shoulder 82 edge 86 defines a first semi-circular notch 84. The edge 86 of tang 80 continues in a curved path until a shoulder 88, at which point the edge of the tang turns inwardly in the general direction toward pivot shaft 24, at about a 90 degree angle, thereby defining a flattened face 92. Continuing in the same counterclockwise direction, the edge 86 curves generally outwardly to define a second semi-circular second notch 94 that is located generally opposite notch 84, and continues to shoulder 62, which as noted previously abuts stop pin 60 when the blade is in the open position shown in FIG. 9.

Operation of the automatic opening is now described.

When blade 14 is in the closed position shown in FIGS. 2 and 8, cross bolt 36 operates to lock the blade and retain it in this position, although spring 26 is constantly exerting rotational pressure on blade 14 in the direction of arrow A in FIG. 8. With specific reference to FIG. 8, the blade 14 is locked in this closed position by the tapered sidewall portion 46 of locking body 42, which wedges between and engages a first locking surface 87 on blade 14, which is defined by the notch 84 in tang 80. In FIG. 8, the locking surface 87 is at about the 10:00 position using the circular bolt 36 as the reference clock face. Arrow B in FIG. 8 illustrates the direction of pressure that is exerted by blade 14 against the locking portion of bolt 36 that is making contact with the blade (at first locking surface 87). Spring 134 urges bolt 36 into its fully extended position—that is, the position in which flange 40 abuts the lip 49 between bores 39 and 43 in handle half 16. In this position, tapered sidewall portion 46 is wedged against the locking surface on blade 14, thereby preventing the blade from moving from the closed to the open position. The blade 14 is held in this closed position (again, preferably with a safety mechanism) until the trigger mechanism 34 is activated.

Operation of trigger mechanism 34 to allow blade 14 to rotate to the open position (arrow A in FIG. 9) is accomplished by pushing button end 38 of bolt 36 inwardly against the force of the compression spring 134 (see arrow A in FIG. 4), which as described above always exerts a spring force urging bolt 36 into the position shown in FIG. 10. Since the overall length of bolt 36 is less than the width of handle 12 measured in bore 43, the bolt is movable in the bore in an up and down fashion. Pushing button 38 so that bolt 36 moves inwardly causes the locking body portion 42 of bolt 36—that is, tapered sidewall portion 46, to disengage from the notch 84 in tang 80 of blade 14. When the bolt 36 is depressed far enough so that edge 58 of bolt 36 passes by edge 86 of tang 80, blade 14 is free to rotate and is pivotally driven toward the open position under the force of spring 26.

Turning to FIG. 4, recall that the rotational position of bolt 36 relative to handle half 18 is fixed by virtue of the cooperation between the flattened portion 41 on flange 40 and the cooperative flattened portion of bore 43 in handle half 16. In the assembled knife, bolt 36 is axially oriented in the handle halves so that the face of the flattened central portion 54 of shank 50 is oriented toward and faces pivot shaft 24. Recall, too, that the shank 50 does not extend past the axial centerline C_{L} that extends through bolt 36. Stated another way, the flattened central portion 54 transects bolt 36 in a position such that the shank 50 occupies less than 50 percent of the distance D shown in FIG. 6, which as noted previously is the diameter of bolt 50 measured at the edge 58 where tapered sidewall portion 46 ends and shank 50 begins. With this geometric configuration, as soon as edge 58 of bolt 36 clears the edge of the tang, the blade rotates from closed to open. As this occurs, shoulder 88 of tang 80 swings past the flattened central portion 54 without touching it and the tang rotates through passageway 59. This is shown in FIG. 6, where it may be seen that shoulder 88 passes by flattened central portion 54 with clearance between the two. Again, because the shank 50 does not extend across the axial centerline of bolt 36, the portion of tang 80 that swings through passageway 59 may be made relatively longer. As such, as best shown in FIG. 6, as the tang 80 swings through the passageway in bolt 36, the tang extends past the axial centerline through the bolt.

With reference once again to FIG. 9, rotation of blade 14 as it moves from the closed position to the open position is stopped when shoulder 62 of tang 80 abuts blade stop pin 60. In this position, spring 26 still exerts force on blade 14 (arrow A). This tends to maintain blade 14 in the fully open position. When the blade is in the open position, the inward pressure on button 38 and thus bolt 36 may be released, allowing the bolt to once again assume the position shown in FIG. 10 under force applied to the bolt by spring 134. In this position, as shown in FIGS. 4, 7 and 9, the tapered sidewall portion 46 of bolt 36 wedges against the flattened face 92 of tang 80, which defines a second locking surface 89 on the tang of blade 14 (see FIG. 7). As best shown in FIG. 9, the corner of tang 80 defined at shoulder 88 does not make contact with the bolt 36. Instead, the point of contact between the bolt 36 and tang 80—the lockup point—second locking surface 89—is on the flattened face 92 at about the 5:00 position, again relying upon the circular bolt as the reference clock face. This lockup defines a compressive force between the bolt and the tang, illustrated by the arrow B. Because the corner defined by shoulder 88 does not contact the bolt, there is no shearing force between the bolt and the tang. The structure of shank 50 allows the length of tang 80 to be effectively increased so that the lockup point 89 is on a planar face of the tang.

By structuring shank 50 as described above, and specifically the manner of making the shank off-set so that the body of the shank does not extend more than 50 percent across the width of bolt 36 at edge 58, makes for a very strong bolt, and allows the length of tang 80 at flattened face 92 to be substantially longer than the tang used in prior art push-button release mechanisms where the shank of the bolt is axially aligned in the bolt. The bolt is stronger because there is more material that defines shank 50. The length of tang 80 at face 92 can be longer because with the geometric configuration of the shank 50, where flattened face portion 54 is less than 50 percent of the distance across the bolt, the longer tang is able to swing past the shank without making contact with it. Because the flattened face 92 defines the contact point with tapered portion 46, there is compressive force applied to the bolt and not a shearing force. The combination of these features produces a far sturdier release pin that is far less prone to failure.

It will be appreciated based on the description above and the drawings that release bolt 36 is movable between two separate positions. The first position is a locking position in which a portion of bolt 36, namely locking portion 42, lies in the space 20 between handle halves 16 and 18 and interacts with the tang 80 of blade 14. The bolt is thus in the first or locking position when the blade is locked closed, and when the blade is locked open. The second position is a release position in which shank 50 lies in space 20 and therefore defines a passageway 59 through which the tang may rotate. The bolt is in the release position whenever the button end 38 is pushed inwardly so that the blade may be automatically rotated from closed to open, and manually rotated from open to closed.

It will further be appreciated that certain modifications may be made to the bolt 36 without changing the principals of the invention. For example, although bolt 36 is illustrated as being cylindrical, the bolt could be of many other different geometric configurations. As another example, the bolt 36 is shown as being retained in the handle 12 by virtue of flange 40. However, there are many equivalent structures that may be used to retain the bolt in the handle. As yet another example of an equivalent structure, in the description above the shank portion 50 of bolt 36 does not extend past the axis through the bolt. However, the shank may be fabricated such that it approaches or even occupies the centerline through the bolt, but in that case the configuration of the tang 80 would need to be modified.

While the present invention has been described in terms of a preferred embodiment, it will be appreciated by one of ordinary skill that the spirit and scope of the invention is not limited to those embodiments, but extend to the various modifications and equivalents as defined in the appended claims.

I claim:

1. Locking and release apparatus for a folding knife, comprising:
a release bolt having a longitudinal axis, and defined by:
a first end portion defining a user-activated portion;
a second end portion defining a locking surface for locking the blade in an open position; and
a shank portion interconnecting the first end portion and the second end portion, wherein the shank portion does not extend across the longitudinal axis.

2. The locking and release apparatus according to claim 1 wherein the shank portion defines a planar wall.

3. The locking and release apparatus according to claim 2 wherein the shank portion defines a passageway having upper and lower walls and a side wall.

4. The locking and release apparatus according to claim 3 wherein the knife includes a blade foldably attached to a handle at a tang portion of the blade, and wherein a portion of the tang passes through the passageway when the blade is moved from the open to the closed position without making contact with the side wall.

5. The locking and release apparatus according to claim 4 wherein when the blade is in the open position a locking surface on the tang portion of said blade makes contact with the locking surface of the second end portion of the release bolt.

6. The locking and release apparatus according to claim 5 wherein the locking surface on the tang portion is defined by a planar surface.

7. The locking and release apparatus according to claim 6 wherein the tang portion includes a shoulder portion adjacent the planar surface, and wherein the shoulder portion extends past the longitudinal axis through the release bolt when the blade moves from the open to closed positions.

8. The locking and release apparatus according to claim 4 wherein the handle defines a handle longitudinal axis and the longitudinal axis of the release bolt is transverse to the handle longitudinal axis, and wherein the release bolt includes anti-rotation means for preventing axial rotation of the release bolt relative to the handle.

9. The locking and release apparatus according to claim 1 in which the knife is an automatic opening knife.

10. The locking and release apparatus according to claim 1 in which the knife is a manual opening knife.

11. In a folding knife having an elongate body defining a longitudinal body axis, and a blade pivotally attached to the body at a tang portion of said blade, and a release bolt retained in the handle and defining a release bolt axis that is transverse to the body axis, the release button operable to lock the blade in the open position, and to release the lock so that the blade may be moved from the open to the closed position, wherein the body includes two opposed sidewalls held in a spaced apart relationship defining a slot therebetween, the improvement comprising:
said release bolt retained in the body such that the release bolt spans the slot, said release bolt having a central shank portion that defines a passageway through which said tang portion is movable as the blade rotates from the open to the closed position, and wherein said central shank portion does not extend past the release bolt axis.

12. The folding knife according to claim 11 wherein the release bolt includes a distal end portion that defines a locking surface, and when the blade is in the open position a locking surface on the tang portion of said blade makes contact with the locking surface of the distal end of the release bolt.

13. The folding knife according to claim 12 wherein the locking surface on the tang portion is defined by a planar surface.

14. The folding knife according to claim 13 wherein the tang portion includes a shoulder adjacent the planar surface, said shoulder portion extending past the longitudinal axis through the release bolt when the blade moves from the open to closed positions.

15. The folding knife according to claim 14 including release bolt anti-rotation means for preventing axial rotation of the release bolt relative to the handle.

16. A push-button type release bolt for a folding knife, comprising:
a first end portion at a first end of the bolt;
a second end portion at a second end of the bolt; and
a passageway between the first and second end portions, said passageway configured for allowing a tang portion of the blade to pass through the passageway as the blade is moved from a closed position to an open position;
wherein, said second end portion defines a locking surface that abuts a planar surface of the tang portion of the blade when the blade is locked in an open position.

17. The release bolt according to claim 16 wherein the bolt defines a longitudinal axis and the passageway is defined by a shank interconnecting the first and second end portions, and said shank does not extend across the longitudinal axis.

18. The release bolt according to claim 16 wherein the bolt defines a longitudinal axis and the passageway is defined by a shank portion having a planar wall.

19. The release bolt according to claim 16 retained in a knife handle, including means for maintaining the rotational position of said release bolt relative to said handle.

20. The release bolt according to claim 19 wherein the means for maintaining the rotational position of said release bolt is defined by a flattened portion on the release bolt that mates with a cooperative flattened portion on said handle.
